(19) United States
(12) Patent Application Publication
(10) Pub. No.: US 2024/0290949 A1
(43) Pub. Date: Aug. 29, 2024

(54) ALL-SOLID-STATE BATTERY AND MANUFACTURING METHOD THEREOF

(71) Applicant: SAMSUNG ELECTRO-MECHANICS CO., LTD.

(72) Inventors: Myungjin Jung, Suwon-si, Gyeonggi-do (KR); Taehoon Kim, Suwon-si, Gyeonggi-do (KR); Minsoo Kim, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/026,655

(22) PCT Filed: Dec. 9, 2022
(86) PCT No.: PCT/KR2022/020016

§ 371 Date: Mar. 16, 2023

(30) Foreign Application Priority Data
Dec. 31, 2021 (KR) 10-2021-0194581
Nov. 7, 2022 (KR) 10-2022-0147343

(51) Int. Cl. H01M 4/36; H01M 10/058; H01M 50/449; H01M 50/466

(52) U.S. Cl. CPC H01M 4/366; H01M 10/058; H01M 50/449; H01M 50/466

(57) ABSTRACT

An all-solid-state battery includes an electrode layer including a current collector extending in a plane direction and an electrode active material layer disposed on at least one surface of the current collector, and a solid electrolyte layer disposed adjacent to the electrode layer in a stacking direction perpendicular to the plane direction, in which the electrode active material layer includes an extension portion extending in the stacking direction and having a portion disposed adjacent to a neighboring electrode active material layer in the plane direction.

### TECHNICAL FIELD

The present disclosure relates to an all-solid-state battery and a manufacturing method thereof.

### BACKGROUND ART

As miniaturization and long-term use of portable electronic devices become common, high-capacity batteries are required, and with the spread of wearable electronic devices, battery safety is required. Therefore, the development of an all-solid-state battery using a solid electrolyte instead of a liquid electrolyte is actively progressing.

The all-solid-state battery is a battery that replaces the existing liquid electrolyte with a solid electrolyte, can greatly reduce the risk of explosion due to flammability of the liquid electrolyte, do not use liquid electrolytes, and thus, have the advantage of being able to operate stably in harsh environments with relatively high temperatures and high pressures. In addition, in the all-solid-state battery, stacking can be realized without a separate cooling unit, the all-solid-state battery has the advantage of realizing a relatively high energy density in the same volume, and thus, it is expected to be used in the future.

The above information disclosed in this Background section is only for enhancement of understanding of the background of the described technology, and therefore it may contain information that does not form the prior art that is already known in this country to a person of ordinary skill in the art.

### DISCLOSURE OF INVENTION

### Technical Problem

The described technology has been made in an effort to provide an all-solid-state battery being designed so that a positive electrode active material or a negative electrode active material constituting the all-solid-state battery has improved capacity within a given volume.

In addition, the described technology has been made in an effort to provide a manufacturing method of an all-solid-state battery being designed so that a positive electrode active material or a negative electrode active material has improved capacity within a given volume.

However, the problems to be solved by the embodiments are not limited to the above-described problems and may be variously expanded within the scope of the technical idea included in the present disclosure.

### Solution to Problem

An embodiment provides an all-solid-state battery including: an electrode layer including a current collector extending in a plane direction and an electrode active material layer disposed on at least one surface of the current collector; and a solid electrolyte layer disposed adjacent to the electrode layer in a stacking direction perpendicular to the plane direction, in which the electrode active material layer includes an extension portion extending in the stacking direction and having a portion disposed adjacent to a neighboring electrode active material layer in the plane direction.

The extension portion may extend from one end portion of the electrode active material layer.

The all-solid-state battery may further include an external electrode connected to the current collector, in which the extension portion may be disposed to be in contact with the external electrode at one end portion of the electrode active material layer.

The solid electrolyte layer may include a bent portion bent in the stacking direction along the extension portion of the electrode active material layer.

The bent portion of the solid electrolyte layer may extend in the stacking direction.

The bent portion of the solid electrolyte layer may be interposed between the extension portion of the electrode active material layer and the neighboring electrode active material layer in the plane direction.

In the electrode layer including another electrode active material layer, the electrode active material layer and the other electrode active material layer may be disposed on both surfaces of the current collector, respectively, and the other electrode active material layer may include an extension portion, so that the extension portions of the electrode active material layers layer and the other electrode active material layer extend from both sides of the current collector in the stacking direction.

The all-solid-state battery may further include an external electrode connected to the current collector and an insulating layer interposed between an edge of the current collector and the external electrode.

The insulating layer may be in contact with the extension portion of the electrode active material layer in the stacking direction.

The electrode layer may include a first electrode layer and a second electrode layer that have different polarities and are disposed in the stacking direction with the solid electrolyte layer interposed therebetween, the first electrode layer may include a first current collector and a first active material layer and the second electrode layer includes a second current collector and a second active material layer, and at least one of the first active material layer or the second active material layer may include an extension portion that extends in the stacking direction and has a portion disposed adjacent to the first active material layer or the second active material layer in the plane direction.

The extension portion of the first active material layer or the second active material layer may extend from one end portion of a corresponding one of the first active material layer or the second active material layer.

The all-solid-state battery may further include a first external electrode connected to the first current collector and a second external electrode connected to the second current collector, and the extension portion of the first active material layer or the second active material layer may be disposed to be in contact with the first external electrode or the second external electrode at the one end portion of the corresponding one of the first active material layer or the second active material layer.

The first active material layer and the second active material layer may each include an extension portion extending in the stacking direction.

The all-solid-state battery may further include a first external electrode connected to the first current collector and a second external electrode connected to the second current collector, the extension portion of the first active material layer may be disposed to be in contact with the first external electrode, and the extension portion of the second active material layer may be disposed to be in contact with the second external electrode.

The first active material layer and the second active material layer may be disposed adjacent to each other with the solid electrolyte layer interposed therebetween, and the extension portions of the first active material layer and the second active material layer may extend in opposite directions along the stacking direction.

The extension portion of the first active material layer and the extension portion of the second active material layer may have different widths along the plane direction.

The first active material layer and the second active material layer may have different thicknesses according to the stacking direction.

Another embodiment provides an all-solid-state battery including: a first electrode layer including a first current collector extending in a plane direction and a first active material layer disposed on at least one surface of the first current collector; a second electrode layer including a second current collector having a polarity different from that of the first electrode layer and extending in the plane direction and a second active material layer disposed on at least one surface of the second current collector; a solid electrolyte layer interposed between the first electrode layer and the second electrode layer; and a first external electrode and a second external electrode respectively connected to the first current collector and the second current collector, in which the first active material layer includes a first extension portion extending in a stacking direction perpendicular to the plane direction from one end portion and having a portion disposed to be in contact with the first external electrode, and the second active material layer includes a second extension portion extending in the stacking direction from one end portion and having a portion disposed to be in contact with the second external electrode.

The first extension portion may have a portion disposed adjacent to the second active material layer in the plane direction, or the second extension portion may have a portion disposed adjacent to the first active material layer in the plane direction.

Yet another embodiment provides a manufacturing method of an all-solid-state battery, the manufacturing method including: forming a first active material layer on a first current collector extending in a plane direction to form a first electrode layer so that the first active material layer has an extension portion extending in a stacking direction perpendicular to the plane direction; forming a second active material layer on a second current collector extending in the plane direction to form a second electrode layer; and stacking the first electrode and the second electrode layer by interposing a solid electrolyte layer between the first active material layer and the second active material layer facing each other. The extension portion of the first active material layer extends to have a portion disposed adjacent to the second active material layer in the plane direction.

The second active material layer may include an extension portion extending in the stacking direction and having a portion disposed to be adjacent to the first active material layer in the plane direction.

Still yet another embodiment provides an all-solid-state battery including: a first electrode layer including a first current collector and a first active material layer disposed on at least one surface of the first current collector; a second electrode layer including a second current collector having a polarity different from that of the first electrode layer and a second active material layer disposed on at least one surface of the second current collector; and a solid electrolyte layer interposed between the first electrode layer and the second electrode layer in a stacking direction. At least one of the first active material layer or the second active material layer has a portion overlapping the solid electrolyte layer in a plane direction perpendicular to the stacking direction.

The first and second active material layers may include first and second extension portions, respectively, each of which protrudes in the stacking direction so as to overlap the solid electrolyte layer in the plane direction.

The solid electrolyte layer may include a first bent portion and a second bent portion bent in opposing directions along the stacking direction.

The first bent portion may be arranged between the first extension portion of the first active material layer and the second active material layer in the plane direction, and the second bent portion may be arranged between the second extension portion of the second active material layer and the first active material layer in the plane direction.

The all-solid-state battery may further include a first external electrode and a second external electrode respectively connected to the first current collector and the second current collector. Insulating layers may be respectively arranged between the first external electrode and the second current collector and between the second external electrode and the first current collector.

### Advantageous Effects of Invention

According to an embodiment, the positive electrode active material or the negative electrode active material constituting the all-solid-state battery may be designed to realize improved capacity within a given volume.

### BRIEF DESCRIPTION OF DRAWINGS

FIG. 1 is a perspective view illustrating an all-solid-state battery according to one embodiment.

FIG. 2 is a partially exploded perspective view illustrating a part of the all-solid-state battery illustrated in FIG. 1.

FIG. 3 is a cross-sectional view taken along line III-III′ of FIG. 1.

FIG. 4 is a cross-sectional view illustrating an all-solid-state battery according to another embodiment.

FIG. 5 is a cross-sectional view illustrating an all-solid-state battery according to still another embodiment.

FIG. 6 is a cross-sectional view illustrating an all-solid-state battery according to still another embodiment.

FIG. 7 is a cross-sectional view illustrating a manufacturing method of the all-solid-state battery illustrated in FIG. 1.

FIG. 8 is an exploded perspective view illustrating the manufacturing method of the all-solid-state battery illustrated in FIG. 1.

### MODE FOR THE INVENTION

Hereinafter, embodiments will be described in detail with reference to the accompanying drawings so that those of ordinary skill in the art can easily carry out the present disclosure. In order to clearly explain the present disclosure in the drawings, parts irrelevant to the description are omitted, and the same reference numerals are assigned to the same or similar components throughout the specification. In addition, in the accompanying drawings, some components are exaggerated, omitted, or schematically illustrated, and the size of each component does not fully reflect the actual size.

The accompanying drawings are only for easy understanding of the embodiments disclosed in this specification, and the technical idea disclosed herein is not limited by the accompanying drawings, and it should be understood to include all modifications, equivalents, and substitutes included in the spirit and scope of the present disclosure.

Terms including ordinal numbers such as first, second, or the like may be used to describe various elements, but the elements are not limited by the terms. The above terms are used only for the purpose of distinguishing one component from another.

Moreover, when a part of a layer, film, region, plate, or the like is said to be “above” or “on” another part, it includes not only cases where it is “immediately on” another part, but also cases where there is another part therebetween. Conversely, when a part is said to be “immediately above” another part, it means that there is no other part therebetween. In addition, to be “above” or “on” the reference part means to be located above or below the reference part, and does not necessarily mean to be located “above” or “on” the opposite direction of gravity.

Throughout the specification, terms such as “include” or “have” are intended to designate that a feature, number, step, operation, component, part, or combination thereof described in the specification is present, but it should be understood that this does not preclude the possibility of addition or existence of one or more other features or numbers, steps, operations, components, parts, or combinations thereof. Therefore, when a part “includes” a certain component, it means that other components may be further included, rather than excluding other components, unless otherwise stated.

In addition, throughout the specification, when it is referred to as “planar view”, it means when the target part is viewed from above, and when it is referred to as “cross-section”, it means when the cross-section obtained by cutting the target part vertically is viewed from the side.

In addition, throughout the specification, when “connected”, this only does not mean that two or more components are directly connected, that is, means that two or more components are indirectly connected through other components, are electrically connected as well as being physically connected, or are integrated with each other even through referred to by different names according to location or function.

In this specification, in describing a stacked all-solid-state battery, a direction in which main components of the all-solid-state battery are stacked is defined as a “stacking direction”, which may also be a “thickness direction”. In addition, a direction parallel to a plane perpendicular to the stacking direction may be defined as a “plane direction”, and the plane direction may include a “longitudinal direction” and a “width direction” that are orthogonal to each other. The longitudinal direction may be a direction in which positive and negative external electrodes face each other, and the width direction may be a direction perpendicular thereto. In the following drawings, an x-axis direction corresponds to the longitudinal direction, a y-axis direction corresponds to the width direction, and a z-axis direction corresponds to the stacking direction.

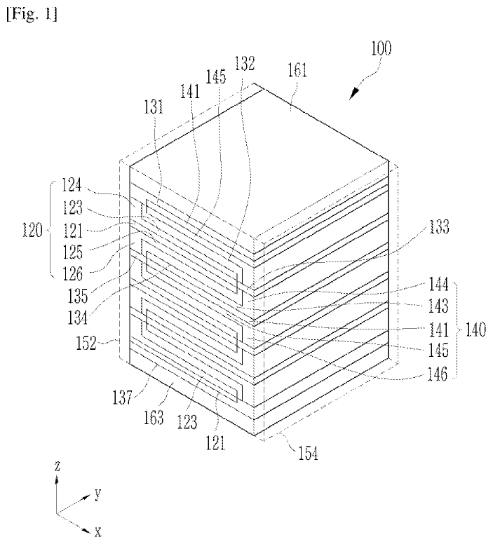

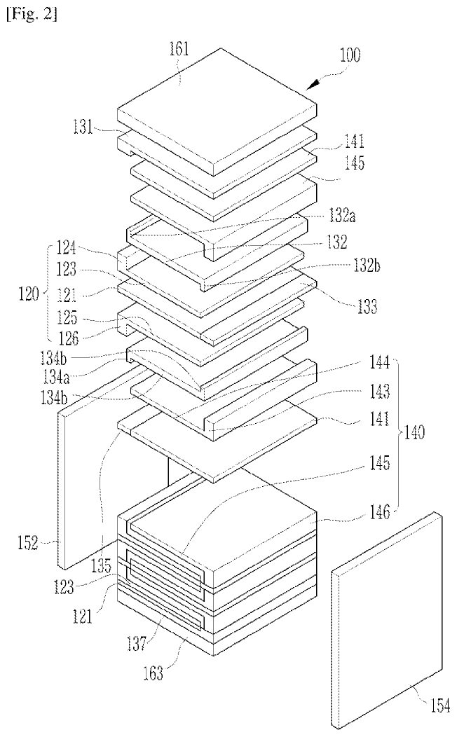

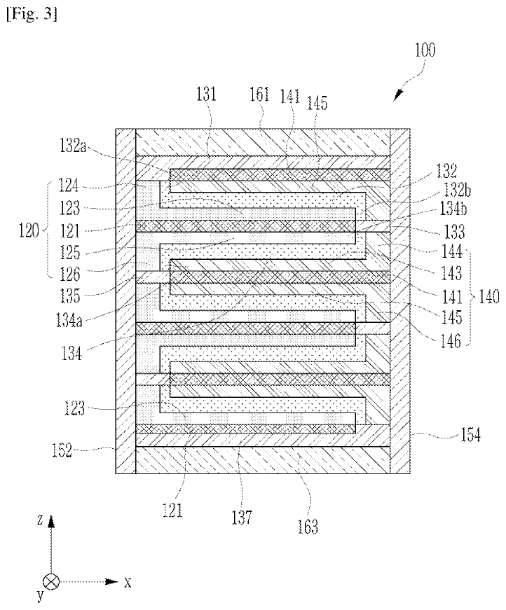

FIG. 1 is a perspective view illustrating an all-solid-state battery 100 according to one embodiment, FIG. 2 is a partially exploded perspective view illustrating a part of the all-solid-state battery 100 illustrated in FIG. 1, and FIG. 3 is a cross-sectional view taken along line III-III′ of FIG. 1.

Referring to FIGS. 1 to 3, the all-solid-state battery 100 according to the present embodiment includes electrode layers 120 and 140 and solid electrolyte layers 132 and 134 disposed adjacent to the electrode layers 120 and 140 in the stacking direction (the z-axis direction in the drawing)

The electrode layers 120 and 140 may basically include current collectors 121 and 141 extending in a plane direction (x-y plane direction in the drawing) and electrode active material layers 123, 125, 143, and 145 coated on at least one surface of the current collectors 121 and 141, respectively.

The electrode active material layers 123, 125, 143, 145 may include extension portions 124, 126, 144, 146 extending in the stacking direction. The extension portions 124, 126, 144, and 146 may have portions disposed adjacent to other electrode active material layers, neighboring in the stacking direction, in the plane direction. In other words, such extension portions 124, 126, 144, and 146 of the electrode active material layers 123, 125, 143, 145 may overlap the other neighboring electrode active material layers in the plane direction. The extension portions 124, 126, 144, and 146 may be formed to extend from one end portions of the respective electrode active material layers 123, 125, 143, 145. In this case, the solid electrolyte layers 132 and 134 may include bent portions 132a, 132b, 134a, and 134b that are bent in the stacking direction along the respective extension portions 124. 126, 144, and 146 of the electrode active material layers 123, 125, 143, and 145. That is, the extension portions 124, 126, 144, and 146 may extend upward or downward in the stacking direction from one end portions along the longitudinal direction (x-axis direction of the drawing) of the electrode active material layers 123, 125, 143, and 145, and the bent portions 132a, 132b, 134a, and 134b may extend upward and downward in the stacking direction in both side end portions in the longitudinal direction of the solid electrolyte layers 132 and 134.

Therefore, the extension portions 124 and 126 of the electrode active material layers 123 and 125 may be disposed to face the other electrode active material layers 143 and 145 adjacent to each other with the bent portions 132a and 134a of the solid electrolyte layer 132 and 134 interposed therebetween. In other words, such extension portions 124 and 126 of the electrode active material layers 123 and 125 may overlap the bent portions 132a and 134a of the solid electrolyte layer 132 and 134, respectively, in the plane direction. When the electrode active material layers 123, 125, 143, and 145 are disposed on both surfaces of each of the current collectors 121 and 141 in the electrode layers 120 and 140, the extension portions 124, 126, 144, and 146 of the electrode active material layers 123, 125, 143, and 145 may extend to both sides in the stacking direction with respect to the current collectors 121 and 141.

In the present embodiment, the electrode layers 120 and 140 may include a positive electrode layer 120 and a negative electrode layer 140, and the solid electrolyte layers 132 and 134 may be stacked to be interposed between the positive electrode layer 120 and the negative electrode layer 140. The solid electrolyte layers 132 and 134 may include a solidified electrolyte and function as a medium for transferring ions between the positive electrode layer 120 and the negative electrode layer 140.

The positive electrode layer 120 may be made by coating at least one surface of the positive electrode current collector 121 with the positive electrode active material layers 123 and 125, and the negative electrode layer 140 may be made by coating at least one surface of the negative electrode current collector 141 with the negative electrode active material layers 143 and 145. For example, the negative electrode layer 140 located at the top of the stacking direction may be formed by coating one surface (lower side) of the negative electrode current collector 141 with the negative electrode active material layer 143, and the positive electrode layer 120 located at the bottom may be formed by coating one surface (upper surface) of the positive electrode current collector 121 with the positive electrode active material layer 123. Moreover, in the electrode layers located between the top and the bottom, the positive electrode layer 120 may formed by coating both surfaces of the positive electrode current collector 121 with the positive electrode active material layers 123 and 125, or the negative electrode layer 140 may be formed both surfaces of the negative electrode current collector 141 with the negative electrode active material layers 143 and 145.

The solid electrolyte layers 132 and 134 may be respectively disposed in the stacking direction between the positive electrode active material layers 123 and 125 of the positive electrode layer 120 and the negative electrode active material layers 143 and 145 of the negative electrode layer 140. Therefore, in the all-solid-state battery 100, a plurality of positive electrode layers 120 and negative electrode layers 140 may be alternately disposed, and a plurality of solid electrolyte layers 132 and 134 may be interposed therebetween to be stacked. As an example, the solid electrolyte layers 132 and 134 may use LATP electrolyte (Li₁₊ₓAlₓTi₂₊ₓ(PO₄)₃(0≤x≤0.6). As another example, a Nasicon-based (Li₁₊ₓAlₓM₂₊ₓ(PO₄)₃) electrolyte or an amorphous (Glass) electrolyte may be used as the solid electrolyte layers 132 and 134, and as still another example, a garnet-type material (Li_{7+x-y}La₃₋ₓ(M1)ₓZe_{2-y}(M2)_{y}O₁₂) (where M1=+divalent element (Ba, or the like) and M2=+pentavalent element (Ta, or the like)), LiPON (Li_{2.9}PO_{3.3}N_{0.46}), or a perovskite structural material (La_{0.51}Li_{0.34}TiO_{2.94}) may be used as the solid electrolyte layers 132 and 134.

In the present embodiment, the positive electrode active material layers 123 and 125 and the negative electrode active material layers 143 and 145 may include the extension portions 124, 126, 144 and 146, respectively, extending in the stacking direction. That is, the extension portions 124, 126, 144, and 146 include positive electrode active material extension portions 124 and 126 and negative electrode active material extension portions 144 and 146, the positive electrode active material extension portions 124 and 126 may extend from the positive electrode active material layers 123 and 125, respectively, and the negative electrode active material extension portions 144 and 146 may extend from the negative electrode active material layers 143 and 145, respectively. The positive electrode active material extension portions 124 and 126 may have portions disposed adjacent to the negative electrode active material layers 143 and 145, respectively, in the plane direction, and the negative electrode active material extension portions 144 and 146 may have portions disposed adjacent to the positive electrode active material layers 123 and 125, respectively, in the plane direction.

The positive electrode active material extension portions 124 and 126 and the negative electrode active material extension portions 144 and 146 may respectively extend in the stacking direction from one end portions of the positive electrode active material layers 123 and 125 and the negative electrode active material layers 143 and 145. Since the positive electrode active material layers 123 and 125 are disposed on both surfaces of the positive electrode current collector 121 in the positive electrode layer 120, the positive electrode active material extension portions 124 and 126 may extend to both sides in the stacking direction with respect to the positive electrode current collector 121. Since the negative electrode active material layers 143 and 145 disposed on both surfaces of the negative electrode current collector 141 in the negative electrode layer 140, the negative electrode active material extension portions 144 and 146 may extend to both sides in the stacking direction with respect to the negative electrode current collector 141.

The positive electrode active material layers 123 and 125 and the negative electrode active material layer 143 and 145 may be disposed adjacent to each other in the stacking direction with the solid electrolyte layers 132 and 134 interposed therebetween. In this case, the positive electrode active material extension portions 124 and 126 may be formed on one end portions of the positive electrode active material layers 123 and 125 that are located at opposite sides to one end portions of the negative electrode active material layers 143 and 145 on which the negative electrode active material extension portions 144 and 146 may be formed, and may extend in opposite directions along the stacking direction.

In addition, the positive electrode active material extension portions 124 and 126 may be disposed to face the negative electrode active material layers 143 and 145 in the plane direction with the bent portions 132a and 134a of the solid electrolyte layers 132 and 134 interposed therebetween, and the negative electrode active material extension portions 144 and 146 may be disposed to face the positive electrode active material layers 123 and 125 in the plane direction with the bent portions 132b and 134b of the solid electrolyte layers 132 and 134 interposed therebetween. Therefore, one side of the solid electrolyte layers 132 and 134 may extend to be bent upward along the stacking direction to form the bent portions 132a and 134b, and the other side of the solid electrolyte layers 132 and 134 may extend to be bent downward along the stacking direction to form the bent portions 132b and 134a.

The positive electrode layer 120, the solid electrolyte layers 132 and 134, and the negative electrode layer 140 may be stacked as described above to constitute a cell stack of the all-solid-state battery 100. An outer insulating layer 131 covering the negative electrode current collector 141 and the positive electrode active material extension portion 124 may be formed in the upper outermost portion of the cell stack of the all-solid-state battery 100, and an outer insulating layer 137 covering the positive electrode current collector 121 and the negative electrode active material extension portion 146 may be formed in the lower outermost portion. In addition, protective layers 161 and 163 made of an insulating material are additionally formed outside these outer insulating layers 131 and 137 to secure ion leakage prevention and insulating performance.

The terminals of the positive electrode current collector 121 and the terminals of the negative electrode current collector 141 may be exposed on both side surfaces of the cell stack of the all-solid-state battery 100, and external electrodes 152 and 154 may be connected and coupled to exposed terminals. That is, the external electrodes 152 and 154 includes an positive external electrode 152 which is connected to the terminal of the positive electrode current collector 121 to have a negative polarity, and an negative external electrode 154 which is connected to the terminal of the negative electrode current collector 141 to have a positive polarity. When the terminal of the positive electrode current collector 121 and the terminal of the negative electrode current collector 141 are configured to face in opposite directions to each other, the external electrodes 152 and 154 may also be located on both sides, respectively.

Insulating layers 133 and 135 may be interposed between one edge of the positive electrode current collector 121 and the negative external electrode 154 and between the other edge of the negative electrode current collector 141 and the positive external electrode 152, respectively. The insulating layers 133 and 135 may be in contact with the positive electrode active material extension portions 124 and 126 in the stacking direction or may be in contact with the negative electrode active material extension portions 144 and 146 in the stacking direction.

The positive electrode active material extension portions 124 and 126 may extend from the positive electrode active material layers 123 and 125 at one end portions where the positive electrode current collector 121 is in contact with the positive external electrode 152, and the negative electrode active material extension portions 144 and 146 may extends from the negative electrode active material layers 143 and 145 at one end portions where the negative electrode current collector 141 is in contact with the negative external electrode 154. Accordingly, the positive electrode active material extension portions 124 and 126 may be disposed to be in contact with the positive external electrode 152, and the negative electrode active material extension portions 144 and 146 may be disposed to be in contact with the negative external electrode 154.

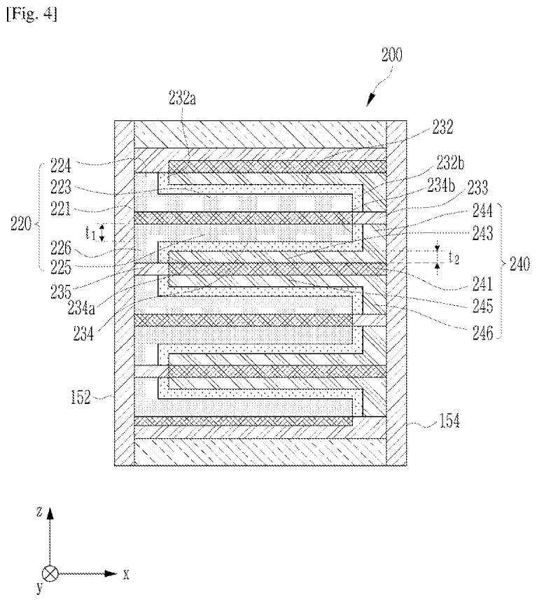

FIG. 4 is a cross-sectional view illustrating an all-solid-state battery 200 according to another embodiment.

Referring to FIG. 4, the all-solid-state battery 200 according to the present embodiment may be configured to include the basic configuration of the all-solid-state battery 100 described with reference to FIGS. 1 to 3.

That is, the all-solid-state battery 200 includes electrode layers 220 and 240 and solid electrolyte layers 232 and 234 disposed adjacent to the electrode layers 220 and 240 in the stacking direction (the z-axis direction of the drawing). The electrode layers 220 and 240 may basically include current collectors 221 and 241 extending in the plane direction (x-y plane direction in the drawing) and electrode active material layer 223, 225, 243, and 245 coated on at least one surface of the current collectors 221 and 241.

The electrode active material layers 223, 225, 243, and 245 may include extension portions 224, 226, 244, and 246 which extend in the stacking direction from one end portions thereof and have portions disposed adjacent to the other neighboring electrode active material layers 223, 225. 243, and 245, respectively, in the plane direction. In this case, the solid electrolyte layer 232 and 234 may include bent portions 232a. 232b, 234a, and 234b which are bent in the stacking direction along the extension portions 224, 226, 244, and 246 of the electrode active material layers 223, 225, 243, and 245.

The electrode layers 220 and 240 may include a positive electrode layer 220 and a negative electrode layer 240, and the solid electrolyte layers 232 and 234 may be stacked to be interposed between the positive electrode layer 220 and the negative electrode layer 240. The positive electrode layer 220 may be made by coating at least one surface of the positive electrode current collector 221 with the positive electrode active material layers 223 and 225, and the negative electrode layer 240 may be made by coating at least one surface of the negative electrode current collector 241 with the negative electrode active material layers 243 and 245. In this case, the positive electrode active material layers 223 and 225 may include positive electrode active material extension portions 224 and 226 extending in the stacking direction from the positive electrode current collector 221, and the negative electrode active material layers 243 and 245 may include negative electrode active material extension portions 244 and 246 extending in the stacking direction from the negative electrode current collector 241. The positive electrode active material extension portions 224 and 226 may have portions disposed to be adjacent to the negative electrode active material layers 243 and 245, respectively, in the plane direction, and the negative electrode active material extension portions 244 and 246 may have portions disposed to be adjacent to the positive electrode active material layers 223 and 225, respectively, in the plane direction.

Insulating layers 233 and 235 may be interposed between one edge of the positive electrode current collector 221 and the negative external electrode 154 and between the other edge of the negative electrode current collector 241 and the positive external electrode 152, respectively. The insulating layers 233 and 235 may be in contact with the positive electrode active material extension portions 224 and 226 in the stacking direction or may be in contact with the negative electrode active material extension portions 244 and 246 in the stacking direction.

In the present embodiment, the positive electrode active material layers 223 and 225 and the negative electrode active material layers 243 and 245 may have different thicknesses t1 and t2 according to the stacking direction. When there is a difference in characteristics per unit volume of a component constituting the positive electrode active material and a component constituting the negative electrode active material, the performance may be balanced by increasing or decreasing the volume of one of the active materials. For example, a thickness t1 of each of the positive electrode active material layers 223 and 225 may be thicker than a thickness t2 of each of the negative electrode active material layers 243 and 245. That is, since the capacities per weight of the negative electrode active material and the positive electrode active material are different, the thickness can be changed so that the capacities of the negative electrode and the positive electrode are equal at the time of design.

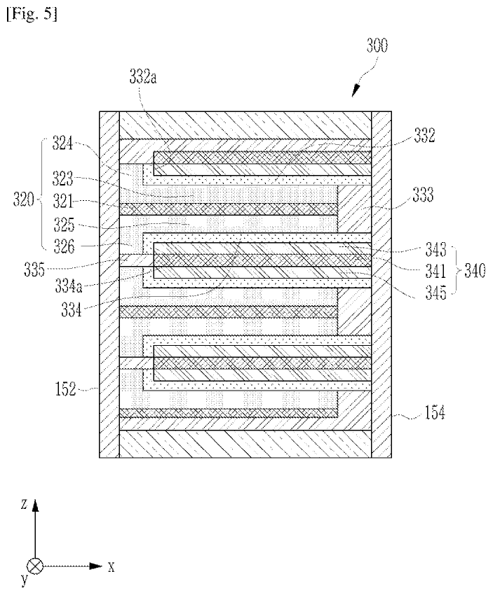

FIG. 5 is a cross-sectional view illustrating an all-solid-state battery 300 according to still another embodiment.

Referring to FIG. 5, the all-solid-state battery 300 according to the present embodiment may be configured to include the basic configuration of the all-solid-state battery 100 described with reference to FIGS. 1 to 3.

That is, the all-solid-state battery 300 includes electrode layers 320 and 340 and solid electrolyte layers 232 and 234 disposed to be adjacent to the electrode layers 320 and 340 in the stacking direction (the z-axis direction of the drawing). The electrode layers 320 and 340 may basically include current collectors 321 and 341 extending in the plane direction (x-y plane direction in the drawing) and electrode active material layer 323, 325, 343, and 345 coated on at least one surface of the current collectors 321 and 341. The solid electrolyte layers 332 and 334 may be disposed to be adjacent to the electrode layers 320 and 340 in the stacking direction.

The electrode layers 320 and 340 may include a positive electrode layer 320 and a negative electrode layer 340, and the solid electrolyte layers 332 and 334 may be stacked to be interposed between the positive electrode layer 320 and the negative electrode layer 340. The positive electrode layer 320 may be made by coating at least one surface of the positive electrode current collector 321 with the positive electrode active material layers 323 and 325, and the negative electrode layer 340 may be made by coating at least one surface of the negative electrode current collector 341 with the negative electrode active material layers 343 and 345.

In the present embodiment, the positive electrode active material layers 323 and 325 may include positive electrode active material extension portions 324 and 326 extending in the stacking direction from one end portions thereof, while the negative electrode active material layers 343 and 345 do not include extension portions. The positive electrode active material extension portions 324 and 326 may have portions disposed adjacent to the negative electrode active material layers 343 and 345, respectively, in a plane direction. The solid electrolyte layers 332 and 334 may include bent portions 332a and 334a, respectively, bent in the stacking direction along the positive electrode active material extension portions 324 and 326.

Insulating layers 333 and 335 may be interposed between one edge of the positive electrode current collector 321 and the negative external electrode 154 and between the other edge of the negative electrode current collector 341 and the positive external electrode 152, respectively. The insulating layers 333 and 335 may be in contact with the positive electrode active material extension portions 324 and 326 or may be in contact with the solid electrolyte layers 332 and 334 in the stacking direction. In this case, the insulating layer 333 in contact with the solid electrolyte layers 332 and 334 may be formed to be thicker in the stacking direction than the insulating layer 335 in contact with the positive electrode active material extension portions 324 and 326.

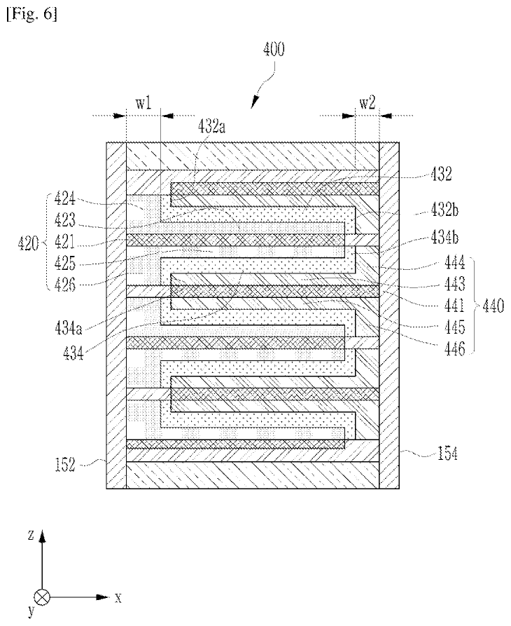

FIG. 6 is a cross-sectional view illustrating an all-solid-state battery 400 according to still another embodiment.

Referring to FIG. 6, the all-solid-state battery 400 according to the present embodiment may be configured to include the basic configuration of the all-solid-state battery 100 described with reference to FIGS. 1 to 3 as well.

That is, the all-solid-state battery 400 includes electrode layers 420 and 440 and solid electrolyte layers 432 and 434 disposed adjacent to the electrode layers 420 and 440 in the stacking direction (the z-axis direction of the drawing). The electrode layers 420 and 440 may basically include current collectors 421 and 441 extending in the plane direction (x-y plane direction in the drawing) and electrode active material layer 423, 425, 443, and 445 coated on at least one surface of the current collectors 421 and 441.

The electrode active material layers 423, 425, 443, and 445 may include extension portions 424, 426, 444, and 446 which extend in the stacking direction from one end portions thereof and have portions disposed adjacent to the other neighboring electrode active material layers 423, 425, 443, and 445 in the plane direction. In this case, the solid electrolyte layer 432 and 434 may include bent portions 432a, 432b, 434a, and 434b which are bent in the stacking direction along the extension portions 424, 426, 444, and 446 of the electrode active material layers 423, 425, 443, and 445.

The electrode layers 420 and 440 may include a positive electrode layer 420 and a negative electrode layer 440, and the solid electrolyte layers 432 and 434 may be stacked to be interposed between the positive electrode layer 420 and the negative electrode layer 440. The positive electrode layer 420 may be made by coating at least one surface of the positive electrode current collector 421 with the positive electrode active material layers 423 and 425, and the negative electrode layer 440 may be made by coating at least one surface of the negative electrode current collector 441 with the negative electrode active material layers 443 and 445. In this case, the positive electrode active material layers 423 and 425 may include positive electrode active material extension portions 424 and 426, respectively, extending in the stacking direction from the positive electrode current collector 421, and the negative electrode active material layers 443 and 445 may include negative electrode active material extension portions 444 and 446, respectively, extending in the stacking direction from the negative electrode current collector 441. The positive electrode active material extension portions 424 and 426 may have portions disposed to be adjacent to the negative electrode active material layers 443 and 445, respectively, in the plane direction, and the negative electrode active material extension portions 444 and 446 may have portions disposed to be adjacent to the positive electrode active material layers 423 and 425, respectively, in the plane direction.

In the present embodiment, the positive electrode active material extension portions 424 and 426 and the negative electrode active material extension portions 444 and 446 may have different widths w1 and w2 in the longitudinal direction (x-axis direction of the drawing). That is, when there is a difference in the characteristics per unit volume of the component constituting the positive electrode active material and the component constituting the negative electrode active material, the performance may be balanced by increasing or decreasing the volume of one of the active materials. For example, a width w1 of each of the positive electrode active material extension portions 424 and 426 may be wider than a width w2 of the negative electrode active material extension portions 444 and 446. Accordingly, it is possible to more easily balance the negative and negative electrode capacities when applying the printing process.

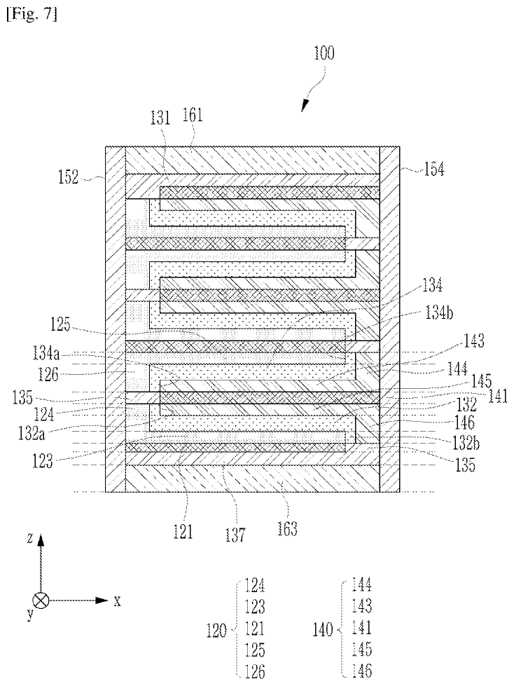

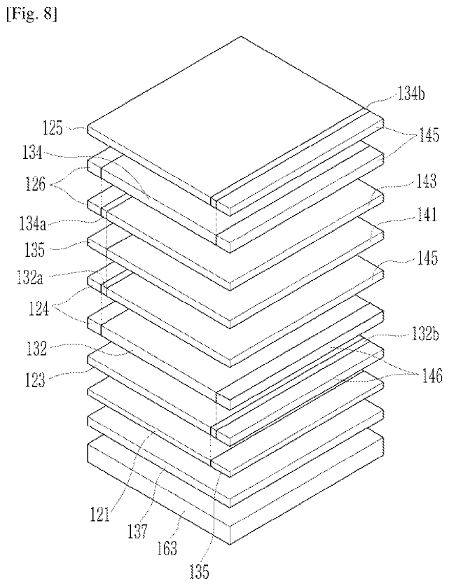

FIGS. 7 and 8 are cross-sectional views and exploded perspective view illustrating a manufacturing method of the all-solid-state battery illustrated in FIG. 1. FIG. 8 schematically illustrates a printing order of an electrode unit including the positive electrode layer 120 and the negative electrode layer 140 positioned at the bottom in the structure of the all-solid-state battery 100 illustrated in FIG. 7.

Referring to FIGS. 7 and 8, in the manufacturing method of the all-solid-state battery 100 according to the present embodiment, the all-solid-state battery may be manufactured by sequentially stacking the components of the electrode layers 120 and 140 on the protective layer 163 and the outer insulating layer 137 using a printing process.

First, the protective layer 163 may be provided, and the outer insulating layer 137 may be stacked thereon. In this case, the outer insulating layer 137 may be formed separately from the protective layer 163. As another example, the outer insulating layer 137 may be integrally made of the same material as the protective layer 163.

Next, the positive electrode current collector 121 may be stacked on the outer insulating layer 137. In this case, the insulating layer 135 may be formed to be adjacent to one end portion of the positive electrode current collector 121, and the positive electrode current collector 121 and the insulating layer 135 may be formed to have the same thickness along the stacking direction (the z-axis direction in the drawing).

The insulating layer 135 may be made of the same material as the outer insulating layer 137, and when the insulating layer 135 is formed of the same material on the outer insulating layer 137, it may be formed integrally.

Next, the positive electrode active material layer 123 may be stacked on the positive electrode current collector 121, and the bent portion 132b of the solid electrolyte layer 132 and the negative electrode active material extension portion 146 may be stacked on the insulating layer 135.

The positive electrode active material layer 123 may be formed to have a size as large as the area of the positive electrode current collector 121, and the bent portion 132b of the solid electrolyte layer 132 and the negative electrode active material extension portion 146 are adjacent to one end portion of the positive electrode active material layer 123. That is, the bent portion 132b of the solid electrolyte layer 132 separates the positive electrode active material layer 123 and the negative electrode active material extension portion 146.

Next, the solid electrolyte layer 132 and the positive electrode active material extension portion 124 may be stacked on the positive electrode active material layer 123, and the negative electrode active material extension portion 146 may be further stacked in the stacking direction. The positive electrode active material extension portion 124 and the negative electrode active material extension portion 146 may be respectively disposed at both ends of the solid electrolyte layer 132, and the solid electrolyte layer 132 may be formed to be integrally connected to the bent portion 132b of the solid electrolyte layer 132.

Next, the negative electrode active material layer 145 may be stacked on the solid electrolyte layer 132 and the negative electrode active material extension portion 146. In addition, the bent portion 132a of the solid electrolyte layer 132 may be formed on the positive electrode-side end portion of the solid electrolyte layer 132, and may be further stacked on the positive electrode active material extension portion 126 to expand in the stacking direction.

Through this process, the positive electrode active material layer 123 may have the extension portion 124 extending in the stacking direction, and the negative electrode active material layer 145 may have the extension portion 146 extending in the stacking direction. In this case, the positive electrode active material extension portion 124 may have the portion disposed to be adjacent to the negative electrode active material layer 145 in the plane direction, and the negative electrode active material extension portion 146 may have a portion disposed to be adjacent to the positive electrode active material layer 123 in the plane direction. In addition, the solid electrolyte layer 132 may be interposed between the positive electrode active material layer 123 and the negative electrode active material layer 145.

Next, the negative electrode current collector 141 may be stacked on the negative electrode active material layer 145, and the insulating layer 135 may be disposed on the positive electrode active material extension portion 124 and the bent portion 132a of the solid electrolyte layer 132. The negative electrode current collector 141 may be formed to have a size equal to the area of the negative electrode active material layer 145.

Next, the negative electrode active material layer 143 may be stacked on the negative electrode current collector 141, and the positive electrode active material extension portion 126 and the bent portion 134a of the solid electrolyte layer 134 may be disposed on the insulating layer 135.

The negative electrode active material layer 143 may be formed to a size as large as the area of the negative electrode current collector 141, and the bent portion 134a of the solid electrolyte layer 134 and the positive electrode active material extension portion 126 is adjacent to one end portion of the negative electrode active material layer 143. That is, the bent portion 134a of the solid electrolyte layer 134 separates the negative electrode active material layer 143 and the positive electrode active material extension portion 126.

Next, the solid electrolyte layer 134 is stacked on the negative electrode active material layer 143 and the solid electrolyte layer 134 may be disposed to be connected to the bent portion 134a. In addition, the positive electrode active material extension portion 126 may be further stacked so as to extend upward in the stacking direction. and the negative electrode active material extension portion 144 may be stacked on the negative electrode active material layer 143 at a negative electrode-side end portion.

Next, the positive electrode active material layer 125 may be stacked on the solid electrolyte layer 134 and the positive electrode active material extension portion 126, and may be further stacked on the negative electrode active material extension portion 144 to expand in the stacking direction. Moreover, the bent portion 134b may extend upward from the positive electrode-side end portion of the solid electrolyte layer 134.

Through the above processes, the electrode layers 120 and 140 and the solid electrolyte layers 132 and 134 may be formed on the protective layer 163 and the outer insulating layer 137, and by repeating the stacking of the electrode layers 120 and 140 and the solid electrolyte layers 132 and 134, the cell stack of the all-solid-state battery 100 may be formed. In addition, the outer insulating layer 131 and the protective layer 161 may be stacked to cover the negative electrode current collector 141 located at the top of the cell stack of the all-solid-state battery 100.

Next, the external electrodes 152 and 154 may be coupled and connected to both surfaces of the cell stack of the all-solid-state battery 100.

In the above, the manufacturing method of the all-solid-state battery illustrated in FIG. 1 has been described, but the all-solid-state battery illustrated in FIGS. 4 to 6 may also be manufactured in the same manner by applying necessary modifications.

Although preferred embodiments have been described above, the present disclosure is not limited thereto, and it is possible to carry out various modifications within the scope of the claims, the description of the disclosure, and the accompanying drawings, and it goes without saying that the modifications also fall within the scope of the present disclosure.

### DESCRIPTION OF SYMBOLS

100, 200, 300, 400: All-solid-state battery
120, 140: Electrode layer (positive electrode layer, negative electrode layer)
121, 141: Current collector (positive electrode current collector, negative electrode current collector)
123, 125: Positive electrode active material layer
124, 126: (Positive electrode active material) extension portion
143, 145: Negative electrode active material layer
144, 146: (Negative electrode active material) extension portion
132, 134: Solid electrolyte layer
132a, 132b, 134a, 134b: (Solid electrolyte layer) Bent portion
131, 137: Outer insulating layer
133, 135: Insulating layer
152, 154: External electrode (positive external electrode, negative external electrode)
161, 163: Protective layer

1. An all-solid-state battery comprising:
an electrode layer including a current collector extending in a plane direction and an electrode active material layer disposed on at least one surface of the current collector; and
a solid electrolyte layer disposed adjacent to the electrode layer in a stacking direction perpendicular to the plane direction,
wherein the electrode active material layer includes an extension portion extending in the stacking direction and having a portion disposed adjacent to a neighboring electrode active material layer in the plane direction.

2. The all-solid-state battery of claim 1, wherein:
the extension portion extends from one end portion of the electrode active material layer.

3. The all-solid-state battery of claim 1, further comprising:
an external electrode connected to the current collector,
wherein the extension portion is disposed to be in contact with the external electrode at one end portion of the electrode active material layer.

4. The all-solid-state battery of claim 1, wherein:
the solid electrolyte layer includes a bent portion bent in the stacking direction along the extension portion of the electrode active material layer.

5. The all-solid-state battery of claim 4, wherein:
the bent portion of the solid electrolyte layer extends in the stacking direction.

6. The all-solid-state battery of claim 4, wherein:
the bent portion of the solid electrolyte layer is interposed between the extension portion of the electrode active material layer and the neighboring electrode active material layer in the plane direction.

7. The all-solid-state battery of claim 1, wherein:
in the electrode layer including another electrode active material layer. the electrode active material layer and the other electrode active material layer are disposed on both surfaces of the current collector, respectively, and
the other electrode active material layer includes an extension portion, so that the extension portions of the electrode active material layers layer and the other electrode active material layer extend from both sides of the current collector in the stacking direction.

8. The all-solid-state battery of claim 1, further comprising:
an external electrode connected to the current collector; and
an insulating layer interposed between an edge of the current collector and the external electrode.

9. The all-solid-state battery of claim 8, wherein:
the insulating layer is in contact with the extension portion of the electrode active material layer in the stacking direction.

10. The all-solid-state battery of claim 1, wherein:
the electrode layer includes a first electrode layer and a second electrode layer that have different polarities and are disposed in the stacking direction with the solid electrolyte layer interposed therebetween,
the first electrode layer includes a first current collector and a first active material layer and the second electrode layer includes a second current collector and a second active material layer, and
at least one of the first active material layer or the second active material layer includes an extension portion that extends in the stacking direction and has a portion disposed adjacent to the first active material layer or the second active material layer in the plane direction.

11. The all-solid-state battery of claim 10, wherein:
the extension portion of the first active material layer or the second active material layer extends from one end portion of a corresponding one of the first active material layer or the second active material layer.

12. The all-solid-state battery of claim 11, further comprising:
a first external electrode connected to the first current collector and a second external electrode connected to the second current collector,
wherein the extension portion of the first active material layer or the second active material layer is disposed to be in contact with the first external electrode or the second external electrode at the one end portion of the corresponding one of the first active material layer or the second active material layer.

13. The all-solid-state battery of claim 10, wherein:
the first active material layer and the second active material layer each include an extension portion extending in the stacking direction.

14. The all-solid-state battery of claim 13, further comprising:
a first external electrode connected to the first current collector and a second external electrode connected to the second current collector,
wherein the extension portion of the first active material layer is disposed to be in contact with the first external electrode, and the extension portion of the second active material layer is disposed to be in contact with the second external electrode.

15. The all-solid-state battery of claim 13, wherein:
the first active material layer and the second active material layer are disposed adjacent to each other with the solid electrolyte layer interposed therebetween, and the extension portions of the first active material layer and the second active material layer extend in opposite directions along the stacking direction.

16. The all-solid-state battery of claim 13, wherein:
the extension portion of the first active material layer and the extension portion of the second active material layer have different widths along the plane direction.

17. The all-solid-state battery of claim 10, wherein:
the first active material layer and the second active material layer have different thicknesses according to the stacking direction.

18. An all-solid-state battery comprising:
a first electrode layer including a first current collector extending in a plane direction and a first active material layer disposed on at least one surface of the first current collector;
a second electrode layer including a second current collector, having a polarity different from that of the first electrode layer, extending in the plane direction and a second active material layer disposed on at least one surface of the second current collector;
a solid electrolyte layer interposed between the first electrode layer and the second electrode layer: and
a first external electrode and a second external electrode respectively connected to the first current collector and the second current collector,
wherein the first active material layer includes a first extension portion extending from one end portion thereof in a stacking direction perpendicular to the plane direction and having a portion disposed to be in contact with the first external electrode, and
the second active material layer includes a second extension portion extending from one end portion thereof in the stacking direction and having a portion disposed to be in contact with the second external electrode.

19. The all-solid-state battery of claim 18, wherein:
the first extension portion has a portion disposed adjacent to the second active material layer in the plane direction, or
the second extension portion has a portion disposed adjacent to the first active material layer in the plane direction.

20. A manufacturing method of an all-solid-state battery, the manufacturing method comprising:
forming a first active material layer on a first current collector extending in a plane direction to form a first electrode layer, wherein the first active material layer has an extension portion extending in a stacking direction perpendicular to the plane direction;
forming a second active material layer on a second current collector extending in the plane direction to form a second electrode layer; and
stacking the first electrode layer and the second electrode layer by interposing a solid electrolyte layer between the first active material layer and the second active material layer facing each other,
wherein the extension portion of the first active material layer extends to have a portion disposed adjacent to the second active material layer in the plane direction.

21. The manufacturing method of claim 20, wherein:
the second active material layer includes an extension portion extending in the stacking direction and having a portion disposed to be adjacent to the first active material layer in the plane direction.

22. An all-solid-state battery comprising:
a first electrode layer including a first current collector and a first active material layer disposed on at least one surface of the first current collector;
a second electrode layer including a second current collector having a polarity different from that of the first electrode layer and a second active material layer disposed on at least one surface of the second current collector; and
a solid electrolyte layer interposed between the first electrode layer and the second electrode layer in a stacking direction,
wherein at least one of the first active material layer or the second active material layer has a portion overlapping the solid electrolyte layer in a longitudinal direction perpendicular to the stacking direction.

23. The all-solid-state battery of claim 22, wherein:
the first and second active material layers include first and second extension portions, respectively, each of which protrudes in the stacking direction so as to overlap the solid electrolyte layer in the longitudinal direction.

24. The all-solid-state battery of claim 23, wherein:
the solid electrolyte layer includes a first bent portion and a second bent portion bent in opposing directions along the stacking direction.

25. The all-solid-state battery of claim 24, wherein:
the first bent portion is arranged between the first extension portion of the first active material layer and the second active material layer in the longitudinal direction, and
the second bent portion is arranged between the second extension portion of the second active material layer and the first active material layer in the longitudinal direction.

26. The all-solid-state battery of claim 23, further comprising:
a first external electrode and a second external electrode respectively connected to the first current collector and the second current collector, wherein insulating layers are respectively arranged between the first external electrode and the second current collector and between the second external electrode and the first current collector.
